(19) United States
(12) Patent Application Publication
(10) Pub. No.: US 2026/0119244 A1
(43) Pub. Date: Apr. 30, 2026

(54) MANAGING CUSTOMER-ENCOUNTERED AI MODEL ISSUES USING SERVICE AGENTS

(71) Applicant: Dell Products L.P., Round Rock, TX (US)

(72) Inventor: DHARMESH M. PATEL, Round Rock, TX (US)

(21) Appl. No.: 18/932,783

(22) Filed: Oct. 31, 2024

(51) Int. Cl. G06F 9/50

(52) U.S. Cl. CPC G06F 9/5027

(57) ABSTRACT

Methods and systems for managing customer-encountered artificial intelligence (AI) model issues using service agents are disclosed. To manage the customer-encountered AI model issues, a service request may be obtained. A first categorization process may be performed for the service request to obtain a type of AI workload. A second categorization process may be performed to obtain a type of support service used to provide the type of AI workload. A third categorization process may be performed to obtain a type of hardware resource used to provide the support service. Based on at least the type of AI workload, the type of support service, the type of hardware resource, and a qualification ranking of the service agents, a service agent may be selected to remediate the customer-encountered AI model issue. The service request may be resolved by assigning the service agent to work the service request.

### FIELD

Embodiments disclosed herein relate generally to issue management. More particularly, embodiments disclosed herein relate to systems and methods to manage customer-encountered AI model issues using service agents.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIG. 3 shows a flow diagram illustrating a method for managing customer-encountered artificial intelligence (AI) model issues using service agents in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing customer-encountered artificial intelligence (AI) model issues using service agents. To manage the customer-encountered AI model issues, service requests for the customer-encountered AI model issues may be worked by the service agents. However, the number of service agents may be limited, thereby limiting the number of service requests that may be worked per unit time. Additionally, in the event that a service agent is assigned to work a service request but fails to resolve the service request, the service request may be escalated and assigned to another service agent to resolve, thereby further reducing the rate of resolution and increasing time to resolution of the service requests. Further, even if a proficient service agent is assigned to work a service request, the assigned service agent may not resolve the service request in a time efficient manner depending on the service agent's level of experience, cognitive bandwidth, and/or other factors.

To improve the rate of resolving service requests by remediating customer-encountered AI model issues within prescribed time goals, categorization processes for the service requests may be implemented. Upon obtaining a service request for a customer-encountered AI model issue (e.g., obtained by a management system from a client device), a first categorization process may be performed to obtain a type of AI workload that gave rise to the customer-encountered AI model issue indicated by the service request. The type of AI workload may include inference generation by an AI model, AI model deployment, AI model distillation, AI model training, AI model updating, etc.

A second categorization process may be performed to obtain a type of support service used to provide the type of AI workload. The type of support service may include file systems management, workload scheduling, database service, hardware resources management, etc.

A third categorization process may be performed to obtain a type of hardware resource used to provide the type of support service. The type of hardware resource may include graphic processing units (GPUs), central processing units (CPUs), hard disk drives, memory modules, etc. By performing the categorization processes, the type of AI workload, the type of support service, and the type of hardware resource indicated by the service request may be obtained.

Based on the type of AI workload, the type of support service, and the type of hardware resource, a portion of service agents of the service agents may be identified that previously remediated customer-encountered AI model issues of the type of AI workload, the type of support service, and the type of hardware resource indicated by the service request. The service agents of the portion of the service agents may be ranked based on efficiency estimates for remediating the customer-encountered AI model issue to obtain a qualification ranking. The efficiency estimates may be based on an average time to resolution of previously remediated customer-encountered AI model issues of the type of AI workload, the type of support service, and the type of hardware resource that were remediated by each service agent of the portion of the service agents. The efficiency estimates may also be based on a level of cognitive bandwidth for each service agent to remediate the customer-encountered AI model issue within a time to resolution goal for the service request. Using the efficiency estimates, the service agents may be ranked to obtain the qualification ranking (e.g., from lowest efficiency estimate to highest efficiency estimate, where a higher efficiency estimate, and thus higher qualification ranking, indicates an increased likelihood that the service agent is able to remediate the customer-encountered AI model issue within the time to resolution goal).

A service agent may be selected based on at least the qualification ranking to remediate the customer-encountered AI model issue. The selected service agent may be assigned to work the service request until resolved or escalated. After resolution or escalation, information regarding the performance of the service agent and the customer-encountered AI model issue may be recorded so that future assignment processes may be more likely to result in desired outcomes (e.g., resolutions of service requests within prescribed goals).

Thus, embodiments disclosed herein may address, among other technical problems, the technical challenge of resource limitations in management systems that manage customer-encountered AI model issues. Due to limited availability of resources, a limited number of service requests may be worked by service agents per unit time. By performing categorization process for the service requests and assigning service agents to work the service requests based on results of the categorization processes, the limited quantity of resources may be able to resolve an increased number of service requests per unit time and in accordance with prescribed goals.

In an embodiment, a method for managing customer-encountered artificial intelligence (AI) model issues using service agents is disclosed. The method may include: obtaining a service request for a customer-encountered AI model issue of the customer-encountered AI model issues; performing a first categorization process for the service request to obtain a type of AI workload that gave rise to the customer-encountered AI model issue indicated by the service request; performing a second categorization process, based on at least the type of AI workload, to obtain a type of support service used to provide the type of AI workload; performing a third categorization process, based on at least the type of support service, to obtain a type of hardware resource used to provide the type of support service; selecting, based on at least the type of AI workload, the type of support service, the type of hardware resource, and a qualification ranking of the service agents, a service agent to remediate the customer-encountered AI model issue, the qualification ranking being based on efficiency estimates for remediating the customer-encountered AI model issue by the service agents; and resolving the service request by assigning the service agent to work the service request.

The type of AI workload may include at least one type of AI workload selected from a list of types of AI workloads consisting of: inference generation by an AI model; AI model deployment; AI model distillation; AI model training; and AI model updating.

The type of support service may include at least one type of support service selected from a list of types of support services consisting of: file systems management; workload scheduling; database services; and hardware resources management.

Selecting the service agent to remediate the customer-encountered AI model issue may include: attempting to identify a portion of the service agents that previously remediated customer-encountered AI model issues of the type of AI workload, the type of support service, and the type of hardware resource indicated by the service request; ranking the service agents of the portion of the service agents based on at least the efficiency estimates for remediating the customer-encountered AI model issue to obtain the qualification ranking; and identifying, based on the qualification ranking, the service agent to remediate the customer-encountered AI model issue.

The efficiency estimates for remediating the customer-encountered AI model issue may be based on: an average time to remediation of previously remediated customer-encountered AI model issues of the type of AI workload, the type of support service and the type of hardware resource that were remediated by each service agent of the portion of the service agents; and a level of available cognitive bandwidth for each service agent of the portion of the service agents to remediate the customer-encountered AI model issue within a time to resolution goal for the service request.

The qualification ranking may include an ordering of the service agents of the portion of the service agents based on the efficiency estimates, and a higher qualification ranking for a service agent may indicate an increased likelihood that the service agent is able to remediate the customer-encountered AI model issue within the time to resolution goal.

Attempting to identify the portion of the service agents may include: in an instance of the attempting where no service agent is identified that previously remediated a customer-encountered AI model issue of the type of AI workload, the type of support service, and the type of hardware resource indicated by the service request: identifying a team of service agents, wherein: each service agent of the team of service agents has previously remediated a customer-encountered AI model issue of at least one selected from a list consisting of the type of AI workload, the type of support service, and the type of hardware resource indicated by the service request; and in combination the team of service agents has previously remediated customer-encountered AI model issues of the type of AI workload, the type of support service, and the type of hardware resource indicated by the service request; and using the team of service agents as the service agent to remediate the customer-encountered AI model issue.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

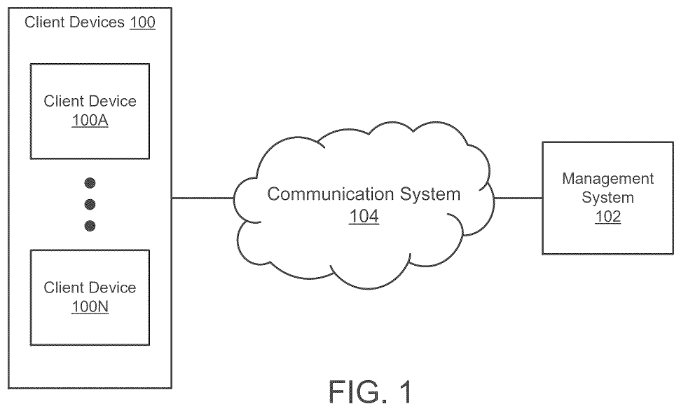

Turning to FIG. 1, a block diagram illustrating a system in accordance with an embodiment is shown. The system shown in FIG. 1 may provide computer-implemented services. The computer implemented services may include any type and quantity of computer-implemented services. For example, the computer-implemented services may include data storage services, instant messaging services, database services, and/or any other type of service that may be implemented with a computing device. The computer-implemented services may be provided, at least in part, using artificial intelligence (AI) models and/or output (e.g., inferences) obtained from the AI models.

To provide the computer-implemented services, the system may include any number of client devices 100. Client devices 100 may provide the computer-implemented services to users of client devices 100 and/or to other devices (not shown). To do so, client devices 100 may train, host, and/or otherwise operate any number and/or type of AI models (e.g., machine learning AI models, generative AI models, deep learning AI models). Client devices 100 may also obtain inferences from AI models hosted by a remote entity (not shown) to provide the computer-implemented services. For example, client device 100A may provide a prompt to an AI model hosted by the remote entity and may receive an inference used to provide the computer-implemented services from the remote entity in response. Different client devices (e.g., 100A, 100N) may provide similar and/or different computer-implemented services.

To provide the computer-implemented services using AI models, AI workloads may be performed (e.g., inference generation by an AI model, AI model deployment, AI model training, AI model distillation, AI model updating). To facilitate performance of the AI workloads, client devices 100 may include various software components (e.g., operating systems, applications, startup managers such as basic input-output systems, etc.) to provide support services for the AI workloads (e.g., file systems management, workload scheduling, database services, hardware resources management). The software components may be hosted by various hardware components (e.g., processors, memory modules, storage devices, etc.). These hardware and software components may facilitate the provision of the computer-implemented services using AI models via their operation.

To perform the AI workloads to provide certain computer-implemented services using AI models, the hardware and/or software components of client devices 100 may need to operate in predetermined manners. If the hardware and/or software components do not operate in the predetermined manners, then a client device may be unable to provide all, or a portion, of the computer-implemented services that it normally provides (and may be expected by the users of the client device to reliably provide).

The hardware and/or software components of client devices 100 may operate differently (e.g., in an undesirable manner) from the predetermined manners for any number of reasons. For example, any of the hardware and/or software components may malfunction. In another example, the hardware and/or software components may be operating normally but in undesirable manners through various interactions such as resource conflicts or constraints. In a further example, various configuration settings of the hardware and/or software components may be set (intentionally or inadvertently) in a manner that causes the operation of any of client devices 100 to be undesirable. The hardware and/or software components of client devices 100 may operate different from the predetermined manners for other reasons (e.g., various root causes) without departing from embodiments disclosed herein. Thus, undesired operation of client devices 100 may result in the AI workloads being unable to be performed in a desired manner for any number of reasons which may be difficult to identify. Consequently, client devices 100 may be unable to provide all and/or a portion of the computer-implemented services.

The undesired operation of client devices 100 may manifest in any number of undesired impacts on the performance of AI workloads, which may be linked to a root cause of the undesired operation. For example, a corrupted hard disk drive may result in the AI model failing to generate inferences when provided with a prompt as ingest. In another example, corrupted software used to provide database services for the AI model may result in the AI model generating inaccurate, erroneous, and/or otherwise undesirable inferences in response to a prompt. In a further example, errors in workload scheduling software may result in an inconsistent ability to obtain inferences from the AI model over time resulting in a client device being unable to obtain inferences when desired. The undesired impacts on the performance of the AI workloads may take other forms without departing from embodiments disclosed herein. Thus, a client device may be unable to provide computer-implemented services using AI models due to any number of root causes resulting in undesired impacts on the performance of AI workloads.

To improve the likelihood of client devices 100 providing desired computer-implemented services using AI models, the system of FIG. 1 may include management system 102. Management system 102 may be tasked with addressing undesired operation of any of client devices 100 resulting in undesired impacts on the performance of AI workloads. However, management system 102 may have limited resources with which to address the undesired operation of client devices 100.

In general, embodiments disclosed herein may provide methods, systems, and/or devices for managing undesired operation of client devices 100 resulting in undesired impacts on the performance of AI workloads. To manage the undesired operation of client devices 100, management system 102 may provide remediation services upon obtaining a service request for a customer-encountered AI model issue. The remediation services may include diagnosing, managing, and otherwise resolving the customer-encountered AI model issue indicated by the service request by a service agent (e.g., a trained person). However, the number of service agents available to work the customer-encountered AI model issue may be limited.

To improve the rate of resolution of the service request, the system may assign the service agent to work the service request based on a combination of demonstrated capabilities of the service agent (e.g., previous service requests worked by the service agent), a qualification ranking (e.g., the qualifications of the service agent may be ranked with respect to qualifications of the service agents), and/or other factors.

To initially identify service agents that are qualified to remediate the customer-encountered AI model issue, categorization processes may be performed for the service request. A first categorization process may be performed for the service request to obtain a type of AI workload (e.g., inference generation, AI model distillation, AI model updating) that gave rise to the customer-encountered AI model issue indicated by the service request. Based on at least the type of AI workload, a second categorization process may be performed to obtain a type of support service used to provide the type of AI workload (e.g., file systems management, hardware resources management). Based on at least the type of support service, a third categorization process may be performed to obtain a type of hardware resource used to provide the type of support service (e.g., hard disk drive, graphics processing unit).

The type of AI workload, the type of support service, and the type of hardware resource obtained from the categorization processes may be used to identify a portion of service agents that previously remediated customer-encountered AI model issues of the type of AI workload, the type of support service, and the type of hardware resource indicated by the service request. To select the service agent to work the service request from the portion of service agents, the service agents of the portion of the service agents may be ranked based on efficiency estimates for remediating the customer-encountered AI model issue to obtain a qualification ranking. Based on the qualification ranking, the service agent may be selected to remediate the customer-encountered AI model issue. The service request may then be resolved by assigning the service agent to work the service request.

By doing so, embodiments disclosed herein may reduce a time to remediate customer-encountered AI model issues indicated by service requests. For example, by selecting the service agents to work the service requests in the manner discussed herein, remediation failures may be reduced. Consequently, these customer-encountered AI model issues may not be worked by service agents that are unlikely to remediate the customer-encountered AI model issues. Accordingly, the customer-encountered AI model issues may be remediated more quickly on average by avoiding: (i) failed attempts at remediation by service agents, (ii) delays in escalation of failed attempts at remediation, and/or (iii) other delays in remediation of customer-encountered AI model issues due to initial assignment of service requests to service agents that are unlikely to be able to resolve the service requests. In doing so, resources (e.g., computing resources, time resources, cognitive resources of service agents) may be conserved. As a result, a likelihood of providing computer-implemented services using AI models may be improved.

To provide the above noted functionality, the system of FIG. 1 may include client devices 100, management system 102, and communication system 104. Each of these components is discussed below.

Client devices 100 may include any number of client devices (e.g., 100A-100N). Each client device of client devices 100 may include hardware and/or software components configured to facilitate the provision of all, or a portion of, the computer-implemented services. Client devices 100 may include, for example, businesses, individuals, and/or devices (e.g., data processing systems) that may use AI models and/or inferences generated by AI models as part of providing the computer-implemented services.

To provide the computer-implemented services, client devices 100 may: (i) train, host, and/or otherwise operate AI models, (ii) obtain prompts for the AI models, (iii) provide the prompts to the AI models as ingest, (iv) obtain inferences from the AI models as output based on the prompts, and/or (v) perform other tasks. The AI models used by client devices 100 may be hosted locally and/or client devices 100 may interact with a remote entity (not shown) responsible for hosting, training, and/or operating the AI models. In a first example, the remote entity may provide inferencing services for client devices 100, and client devices 100 may use the inferences generated by the AI models hosted by the remote entity to provide the computer-implemented services. In a second example, the AI models may be hosted by client devices 100, and the client devices may use inferences generated by the AI models to provide the computer-implemented services.

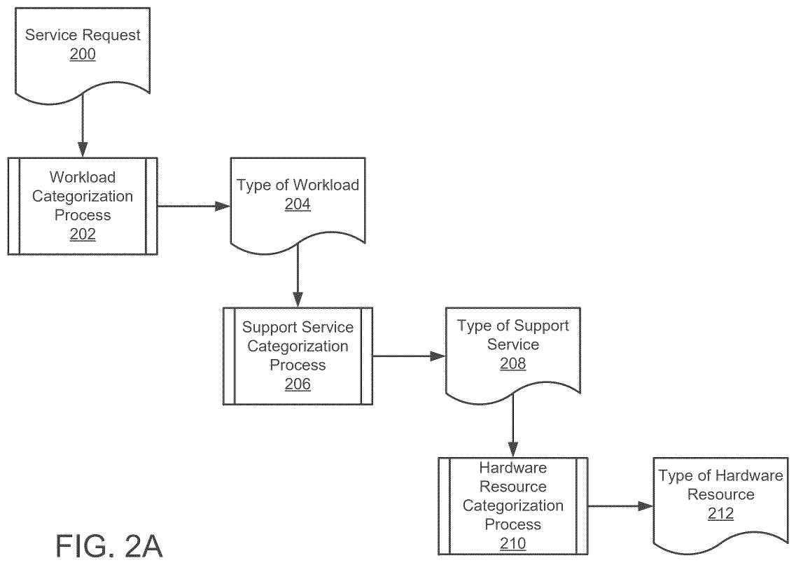

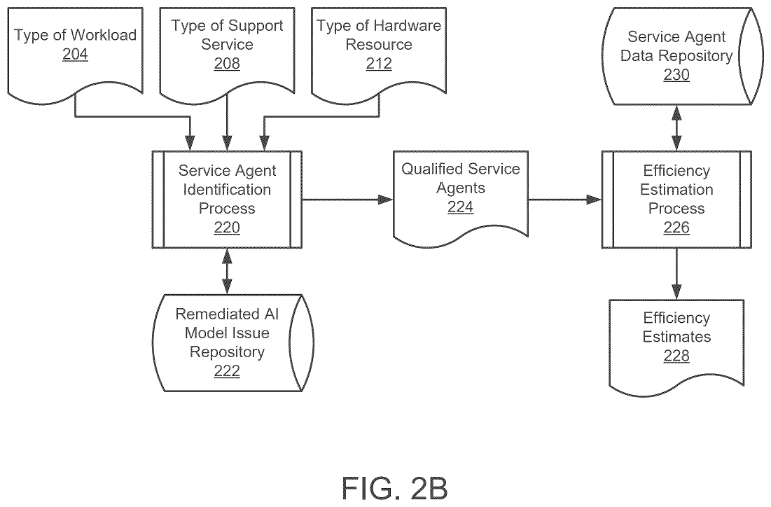

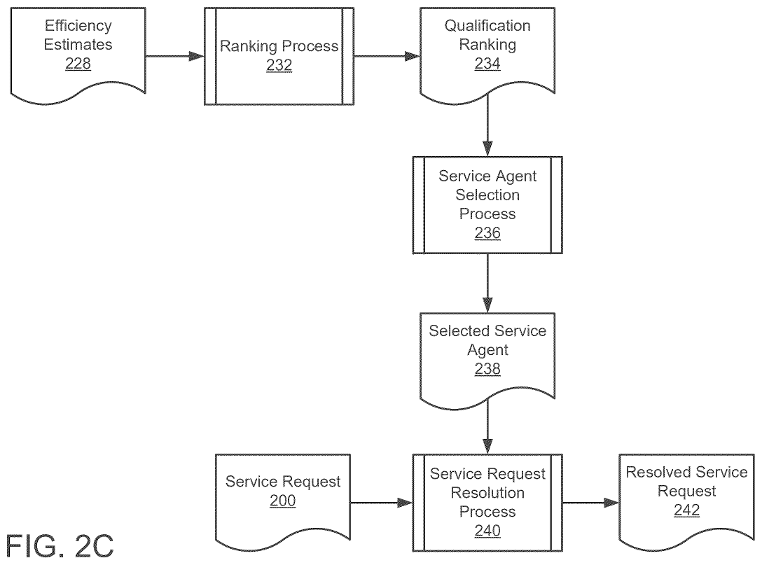

To facilitate provision of the computer-implemented services, client devices 100 may be managed by management system 102. Management system 102 may include any number and/or type of devices (e.g., data processing systems) used to provide remediation services for client devices 100. To provide the remediation services, management system 102 may: (i) receive a service request from a user of client devices 100 regarding a customer-encountered AI model issue (e.g., undesired operation of client devices 100 encountered by the user thereof resulting in an undesired impact on AI workloads) and/or may obtain other information from a user of client devices 100 (e.g., telemetry data such as error alerts, logs that indicate operation of a client device), (ii) perform categorization processes for the service request (e.g., to obtain a type of AI workload, a type of support service, and/or a type of hardware resource based on the service request), (iii) identify, based on a result of the categorization processes, a portion of the service agents likely to be proficient in remediating the customer-encountered AI model issue, (iii) perform any number and/or type of efficiency, similarity, and scheduling analyses with respect to the portion of the service agents to obtain an efficiency estimate for each service agent of the portion of the service agents, (iv) rank the service agents based on the efficiency estimates to obtain a qualification ranking, (v) identify, based on at least the qualification ranking, one of the portion of the service agents to remediate the customer-encountered AI model issue, (vi) assign the identified service agent to work the service request to resolution (or until escalated due to failure to remediate the customer-encountered AI model issue), and/or (vii) document the resolution and/or escalation so that future assignments of service agents are completed using up to date information. Refer to FIG. 2A for additional details regarding performing categorization processes for service requests. Refer to FIGS. 2B-2C for additional details regarding assignment of service agents to work service requests.

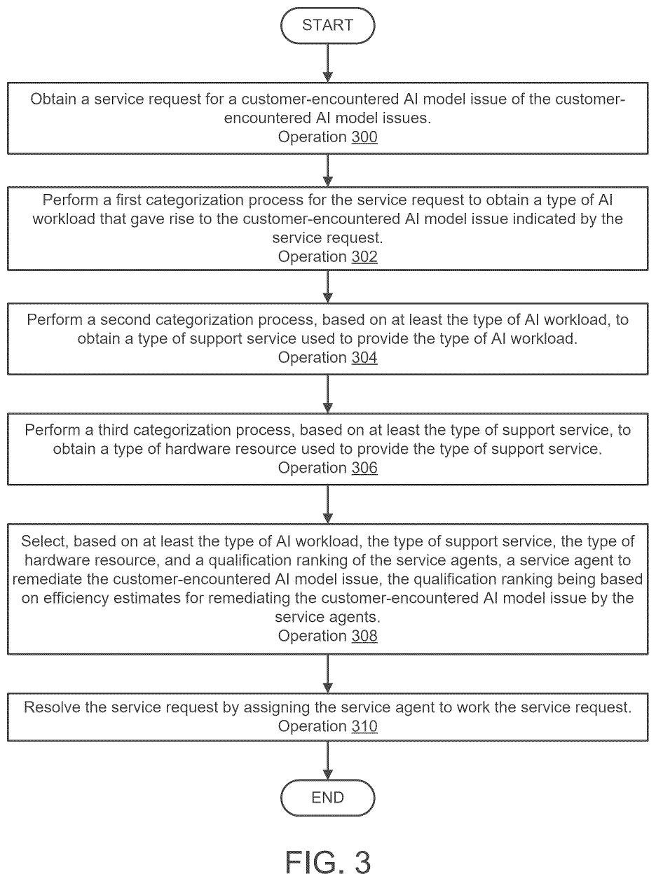

When providing their functionality, any of (and/or components thereof) client devices 100 and/or management system 102 may perform all, or a portion, of the actions and methods illustrated in FIGS. 2A-3.

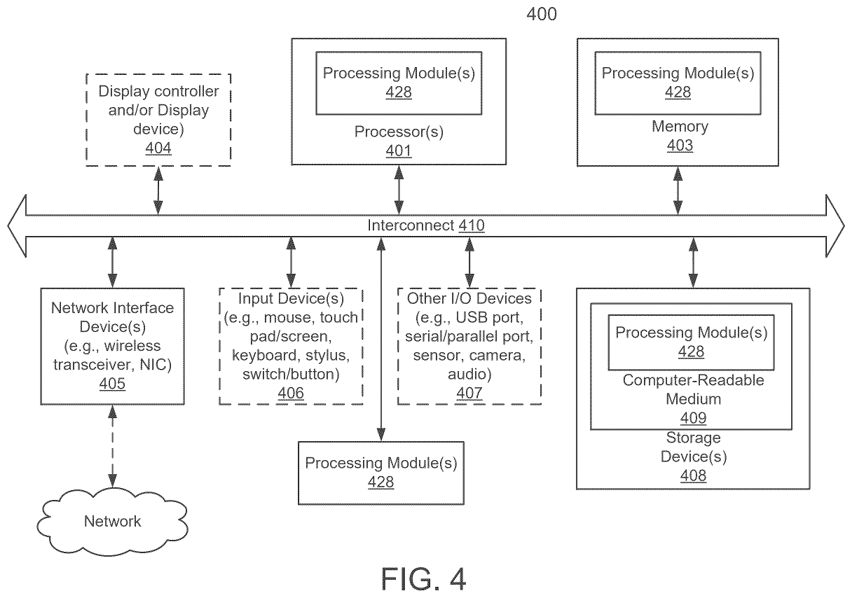

Any of (and/or components thereof) client devices 100 and/or management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Management system 102 may be implemented with multiple computing devices. The computing devices of management system 102 may cooperatively perform processes for managing customer-encountered AI model issues. The computing devices of management system 102 may perform similar and/or different functions, and may be used by different persons that may participate in the management of the customer-encountered AI model issues. For example, management system 102 may include multiple computing devices used by different service agents (e.g., persons) tasked with resolving service requests.

Management system 102 may be maintained, for example, by a business or other entity that has some degree of responsibility with respect to maintaining the operation of client devices 100. For example, management system 102 may be operated by a business that sells client devices 100 and provides warranty or other types of support for client devices 100 to users and/or owners thereof.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

The system described in FIG. 1 may be used to manage customer-encountered AI models issues using service agents to improve an availability and/or quality of computer-implemented services provided to downstream consumers of the computer-implemented services. The following processes described in FIGS. 2A-2C may be performed by the system in FIG. 1 when providing this functionality.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 204, etc.) is used to represent data structures, a second set of shapes (e.g., 202, 206, etc.) is used to represent processes performed using and/or that generate data, and a third set of shapes (e.g., 222, 230) is used to represent large scale data structures such as databases.

Turning to FIG. 2A, a first data flow diagram in accordance with an embodiment is shown. The first data flow diagram may illustrate data used in and data processing performed in performing categorization processes for a service request (e.g., service request 200) to obtain a type of AI workload (e.g., type of workload 204), a type of support service (e.g., type of support service 208), and/or a type of hardware resource (e.g., type of hardware resource 212) based on service request 200.

To perform the categorization processes, service request 200 for a customer-encountered AI model issue may be obtained (e.g., by management system 102 from a client device of client devices 100, refer to FIG. 1). Service request 200 may be a data structure that includes information regarding the customer-encountered AI model issue. Service request 200 may be obtained by (i) obtaining information regarding the customer-encountered AI model issue, and (ii) adding the obtained information to a new or existing data structure representing a service request. The information may be obtained, for example, by (i) receiving the information via a portal (e.g., a website), (ii) receiving the information via phone calls, video calls, instant messages, and/or via other types of interactions with users (which may be subsequently subjected to processing to derive recordable information regarding the user and the customer-encountered AI model issue), and/or (iii) via other methods.

The information obtained as part of service request 200 may include: (i) text describing the customer-encountered AI model issue, (ii) telemetry, performance, and/or other data obtained from the client device experiencing the customer-encountered AI model issue (e.g., obtained in a response following a request for the data, obtained automatically upon receiving service request 200), (iii) responses to a list of questions provided to the user reporting the customer-encountered AI model issue (e.g., via a questionnaire provided to the user automatically upon obtaining service request 200), and/or (iv) other information usable to assist in remediating the customer-encountered AI model issue. The information obtained as part of service request 200 may be compared to existing records regarding the client device to verify the existing records are accurate and/or update the existing records with current device information.

Upon obtaining service request 200 from a user of a client device, workload categorization process 202 may be performed. During workload categorization process 202, a first categorization process may be performed for service request 200 to obtain a type of AI workload that gave rise to the customer-encountered AI model issue indicated by service request 200 (e.g., type of workload 204). Type of workload 204 may include: (i) inference generation by an AI model (e.g., obtaining output from the AI model in response to prompts), (ii) AI model deployment (e.g., moving the AI model from an offline environment to a production environment), (iii) AI model distillation (e.g., transferring knowledge from a large AI model to a smaller one), (iv) AI model training (e.g., setting weights and/or other parameters of the AI model based on a training dataset to enable the model to generate inferences in a desired manner), (v) AI model updating (e.g., adjusting weights and/or other parameters of the AI model to improve performance via reinforcement learning and/or other methods), and/or (vi) other types of AI model workloads.

To obtain type of workload 204, information regarding the customer-encountered AI model issue, data regarding the client device, and/or responses to the list of questions obtained as part of service request 200 may be used to identify type of workload 204. For example, a user of a client device may provide a service request including information indicating that the user is obtaining inferences intermittently upon providing an AI model a prompt and at times is unable to obtain inferences (e.g., the customer-encountered AI model issue). Upon obtaining the information, the user may be automatically prompted to answer a list of questions regarding the customer-encountered AI model issue to obtain other information, such as a duration of time over which the issue has occurred, times of the day the issue occurs most frequently, actions already taken by the user to attempt to remediate the issue, etc. Other information may also be obtained (e.g., from the user, via a backend connection to the client device), such as a type of AI model (e.g., machine learning model, natural language processing model, generative model), a version of the AI model, resource consumption of the AI model, telemetry data for the client device, etc.

The information obtained as part of service request 200 may be used to determine whether service request 200 indicates the issue experienced by the user is AI model related. For example, based on the answers provided by the user to the list of questions, it may be determined that the issue is not AI model related. For example, it may be determined that the issue is due to user error, equipment failure, and/or any other type of issue experienced while providing computer-implemented services that is not related to using the AI model.

If it is determined that the issue experienced by the user is AI model related, the information included as part of service request 200 may be used to obtain type of workload 204. Type of workload 204 may be obtained via an automatic and/or manual process using the information. For example, a rule set for obtaining types of AI workloads may be used to assign type of workload 204 based on the user answers to the list of questions. In another example, a large language model (LLM) may process text included in service request 200 to identify type of workload 204. In a further example, a user of management system 102 (e.g., a service agent, a subject matter expert (SME)) may determine type of workload 204 based on the information. Continuing with the above example where the customer-encountered AI model issue includes intermittent and/or an inability to obtain inferences, the type of AI workload may be identified as inference generation by the AI model.

Upon obtaining type of workload 204, support service categorization process 206 may be performed. During support service categorization process 206, a second categorization process may be performed, based on at least type of workload 204, to obtain a type of support service used to provide the type of AI workload (e.g., type of support service 208). Type of support service 208 may include any number and/or type of software-based services used to perform the type of AI model workload, including: (i) file systems management (e.g., file organization, management, and/or tracking), (ii) workload scheduling (e.g., planning, scheduling, balancing, prioritizing, and/or allocating resources to perform workloads), (iii) database services (e.g., storing, managing, and/or obtaining data stored in a database and/or other storage architecture), (iv) hardware resources management (e.g., allocating and/or managing use of hardware resources), and/or (v) other types of support services.

Performing the second categorization process may include: (i) obtaining type of support service 208 based on the information provided by the user (e.g., answers to the list of questions indicating type of support service 208, information regarding the customer-encountered AI model issue indicating type of support service 208), (ii) generating type of support service 208 based on type of workload 204 (e.g., based on a rule set and/or schema), (iii) prompting the user, based on type of workload 204, to answer additional questions regarding the customer-encountered AI model issue, and/or (iv) other methods.

Obtaining the type of support service based on the information provided by the user may include identifying type of support service 208 automatically and/or manually based on information provided by the user and/or obtained from the client device regarding the customer-encountered AI model issue. For example, the user may provide information indicating that while attempting to feed ingest data to the AI model during AI model training (e.g., type of workload 204), the user received an error message indicating an issue with the file systems management software. In this example, type of support service 208 for the AI model training workload may be obtained from the information provided by the user.

Generating type of support service 208 based on type of workload 204 may include automatically and/or manually assigning type of support service 208 using a rule set, schema, and/or table which maps types of AI workloads to types of support services used to provide the types of AI workloads. For example, if it is determined that type of workload 204 is AI model training, a lookup process may be performed using the AI model training workload as a key for a lookup table to determine that type of support service 208 includes database services and hardware resources management.

Prompting the user to answer additional questions regarding the customer-encountered AI model issue to obtain type of support service 208 may include automatically providing a list of questions usable to determine type of support service 208 based on type of workload 204. For example, if it is determined that type of workload 204 is AI model updating, the user may be prompted to answer questions regarding any error messages the user may have received, at what point of the AI model updating workload the user encountered an issue, etc. Type of support service 208 may then be obtained based on the answers provided by the user.

Upon obtaining type of support service 208, hardware resource categorization process 210 may be performed. During hardware resource categorization process 210, a third categorization process may be performed, based on at least type of support service 208, to obtain a type of hardware resource used to provide the type(s) of support service (e.g., type of hardware resource 212). Type of hardware resource 212 may include any number and/or type of hardware components, which may include specialized hardware components for performing AI workloads. Type of hardware resource 212 may include hard disk drives, memory modules, central processing units (CPUs), graphics processing units (GPUs), tensor processing units (TPUs), accelerated processing units (APUs), network interface cards (NICs), and/or other types of hardware resources.

Performing the third categorization process may include: (i) obtaining type of hardware resource 212 based on the information provided by the user (e.g., answers to the list of questions indicating a type of hardware resource), (ii) generating type of hardware resource 212 based on type of support service 208 (e.g., based on a rule set and/or schema), (iii) prompting the user, based on type of support service 208, to answer additional questions regarding the customer-encountered AI model issue usable to determine type of hardware resource 212, and/or (iv) other methods. For example, if it is determined that type of support service 208 includes workload scheduling to perform inference generation workloads, a schema for mapping types of support services to types of hardware resources may be used to obtain type of hardware resource 212, which may include a GPU used to perform the inference generation workloads.

Thus, by implementing the flow shown in FIG. 2A, a system in accordance with embodiments disclosed herein may allow service requests for customer-encountered AI model issues to be categorized based on a type of AI workload, a type of support service, and a type of hardware resource of the customer-encountered AI model issue. The categorizations may be used to make service agents assignments to work the service requests that are more likely to meet goals for resolving service requests (e.g., time goals, financial goals, etc.).

Turning to FIG. 2B, a second data flow diagram in accordance with an embodiment is shown. The second data flow diagram may illustrate data used in and data processing performed, at least in part, in selecting a service agent to remediate a customer-encountered AI model issue by obtaining efficiency estimates (e.g., efficiency estimates 228) for a portion of service agents.

To select the service agent to remediate the customer-encountered AI model issue, service agent identification process 220 may be performed. During service agent identification process 220, type of workload 204, type of support service 208, and/or type of hardware resource 212 may be used to attempt to identify a portion of the service agents that previously remediated customer-encountered AI model issues of the type of AI workload, the type of support service, and the type of hardware resource indicated by the service request (e.g., service request 200, refer to FIG. 2A). In doing so, past performances of the service agents may be evaluated to obtain qualified service agents 224.

To obtain qualified service agents 224, a lookup process may be performed using remediated AI model issue repository 222. Remediated AI model issue repository 222 may include a log, database, and/or other type of storage structure used to store information regarding previously remediated customer-encountered AI model issues. For example, remediated AI model issue repository 222 may include an entry for each previously remediated customer-encountered AI model issue. Each entry may include: (i) a type of AI model workload, a type of support service, and a type of hardware resource for the previously remediated customer-encountered AI model issue, (ii) identifiers for any of the service agents that participated in remediating the previously remediated customer-encountered AI model issue (e.g., service agent names, identification numbers, and/or other identifiers), and/or (iii) other information.

Performing the lookup process using remediated AI model issue repository 222 may include using type of workload 204, type of support service 208, and/or type of hardware resource 212 as a key for a lookup table included in remediated AI model issue repository 222. As a result of the lookup process, entries may be identified which include previously remediated customer-encountered AI model issues of type of workload 204, type of support service 208, and type of hardware resource 212. From each of the identified entries, the service agent responsible for remediating the previously remediated customer-encountered AI model issue may be obtained to obtain qualified service agents 224. Qualified service agents 224 may include a list of service agents including the portion of service agents that were identified that previously remediated customer-encountered AI model issues of type of workload 204, type of support service 208, and type of hardware resource 212.

If an entry indicates more than one service agent worked on the previously remediated customer-encountered AI model issue, only the service agent(s) responsible for remediating the previously remediated customer-encountered AI model issue may be included in qualified service agents 224. For example, a service request for the previously remediated customer-encountered AI model issue may have been worked by a first service agent who was unable to remediate the issue. As a result, a second service agent may have been assigned the service request, and the second service agent may have remediated the issue. While both service agents may be documented in the entry in remediated AI model issue repository 222, only the second service agent may be included in qualified service agents 224.

While attempting to identify the portion of the service agents that previously remediated customer-encountered AI model issues of type of workload 204, type of support service 208, and type of hardware resource 212, a service agent may be unable to be identified. If a service agent is unable to be identified, a team of service agents may be identified. Each service agent of the team of service agents may have previously remediated a customer-encountered AI model issue of at least one selected from a list consisting of type of workload 204, type of support service 208, and type of hardware resource 212. The team of service agents may be identified so that in combination the team of service agents has previously remediated customer-encountered AI model issues of type of workload 204, type of support service 208, and type of hardware resource 212. The team of service agents may then be used as the service agent to remediate the customer-encountered AI model issue.

For example, based on a service request received from a user of a client device, it may be determined that the customer-encountered AI model issue indicated by the service request includes an AI model distillation workload, a file systems management support service, and a hard disk drive hardware resource. A lookup may be performed in remediated AI model issue repository 222, and it may be determined that no entries include previously remediated customer-encountered AI model issues of the type of AI model workload, support service, and hardware resource indicated by the service request. As a result, a team of service agents may be selected. For example, the team of service agents may include 3 service agents: a first service agent that has previously remediated an AI model distillation workload issue, a second service agent that has previously remediated a file systems management support service issue, and a third service agent that has previously remediated a hard disk drive hardware resource issue. Thus, in combination, the team of service agents may have previously remediated customer-encountered AI model issues of the type of AI model workload, support service, and hardware resource indicated by the service request.

While qualified service agents 224 may be likely to be able to resolve the customer-encountered AI model issue indicated by the service request, the service agents of qualified service agents 224 may be further ranked to identify a service agent that is likely to be able to remediate the customer-encountered AI model issue in a time efficient manner. To do so, efficiency estimation process 226 may be performed.

During efficiency estimation process 226, past performances of each service agent and/or current cognitive availability of qualified service agents 224 may be evaluated to obtain efficiency estimates 228. Efficiency estimates 228 may include an estimated time to resolve the service request for each service agent. For example, when a service request is resolved, performance data and/or other metrics regarding the resolution process may be stored in an entry in service agent data repository 230. Each entry in service agent data repository 230 may correspond to a service agent, and may include: (i) an identifier for the service agent (e.g., a name, an identification number), (ii) a duration of time for the service agent to remediate previously resolved customer-encountered AI model issues, (iii) a cognitive bandwidth availability estimate for the service agent (e.g., based on current service request assignments and/or other duties of the service agent), and/or (iv) other information.

To obtain efficiency estimates 228, data for each service agent of qualified service agents 224 may be obtained from service agent data repository 230 and analyzed via any method to obtain an efficiency estimate for each service agent. Each efficiency estimate may be based on: (i) an average time to remediation of previously remediated customer-encountered AI model issues of type of workload 204, type of support service 208, and type of hardware resource 212, and/or (ii) a level of available cognitive bandwidth for each service agent (e.g., based on any scale and/or quantification) to remediate the customer-encountered AI model issue within a time to resolution goal for the service request. The time to resolution goal for the service request: (i) may be provided by the user of the client device experiencing the customer-encountered AI model issue, (ii) may be determined by management system 102, and/or (iii) may be established by any other entity.

For example, a first service agent and a second service agent included in qualified service agents 224 may have an average time to remediation of previously remediated customer-encountered AI model issues of type of workload 204, type of support service 208, and type of hardware resource 212 of 15 minutes and 20 minutes, respectively. However, the first service agent and the second service agent may have a level of available cognitive bandwidth of 1 and 5, respectively (e.g., on a scale of 1-5, where 5 represents the highest level of cognitive bandwidth available). Consequently, the first service agent may be assigned an efficiency estimate that is lower than the second service agent (e.g., a predicted time to resolution for the service request may be greater for the first service agent than the second service agent) due to limited availability of cognitive bandwidth.

Thus, by implementing the processes illustrated in FIG. 2B, a system in accordance with an embodiment may be used to obtain efficiency estimates for a portion of service agents that are likely to be able to remediate the customer-encountered AI model issue. The efficiency estimates may be used to select service agents to work service requests that are likely to remediate the customer-encountered AI model issue in a time efficient manner based on their past experience, cognitive bandwidth, and other capabilities.

Turning to FIG. 2C, a third data flow diagram in accordance with an embodiment is shown. The third data flow diagram may illustrate data used in and data processing performed in resolving a service request for a customer-encountered AI model issue (e.g., service request 200) using a service agent selected, at least in part, based on a qualification ranking of service agents (e.g., qualification ranking 234).

To select a service agent to resolve service request 200, qualification ranking 234 may be obtained. Qualification ranking 234 may include an ordering of the service agents of a portion of the service agents that previously remediated customer-encountered AI model issues of the type of AI workload, the type of support service, and the type of hardware resource indicated by the service request (e.g., qualified service agents 224, refer to FIG. 2B) based on efficiency estimates 228. A higher qualification ranking for a service agent may indicate an increased likelihood that the service agent is able to remediate the customer-encountered AI model issue within the time to resolution goal.

To obtain qualification ranking 234, ranking process 232 may be performed. During ranking process 232, efficiency estimates 228 may be used to rank service agents of a portion of the service agents (e.g., qualified service agents 224, refer to FIG. 2B). For example, the service agents of the portion of the service agents may be ranked from shortest to longest estimated time to resolve the service request indicated by efficiency estimates 228, with being ranked as the shortest time to resolve being considered the best ranked service agent. Thus, the best ranked service agent may have the highest likelihood of remediating the customer-encountered AI model issue within the time to resolution goal of the service request.

Once qualification ranking 234 is obtained, service agent selection process 236 may be performed. During service agent selection process 236, the service agent to remediate the customer-encountered AI model issue may be selected based on at least qualification ranking 234. For example, the best ranked service agent may be selected to remediate the customer-encountered AI model issue to obtain selected service agent 238.

Other factors may also be considered during service agent selection process 236 which may delay resolution of service request 200 if assigned to a particular service agent. The other factors may include: (i) a location where the service agent is located and location where the service agent may need to travel to work service request 200, (ii) a level of severity of impact of the customer-encountered AI model issue associated with service request 200, (iii) a level of financial cost for tasking the service agent, (iv) a cost (e.g., time, cognitive load, etc.) for switching from current assignments to working service request 200, and (v) a goal time for resolving service request 200. For example, these factors may each be represented by a numerical value. Information usable to quantify these factors into the numerical value may be stored in a database (e.g., which may store information regarding these factors and rules for scoring these factors, not shown). The scores for these factors may be used to further rank and refine qualification ranking 234 to identify an ordering of the service agents from most desirable to be assigned to work service request 200 to least desirable to work service request 200. The most desirable service agent may then be selected to remediate the customer-encountered AI model issue to obtain selected service agent 238.

Upon obtaining selected service agent 238, service request resolution process 240 may be performed. During service request resolution process 240, service request 200 may be resolved by assigning selected service agent 238 to work service request 200. As a result, resolved service request 242 may be obtained. Resolved service request 242 may be a data structure that includes information regarding the remediated customer-encountered AI model issue, including: (i) a type of AI model workload, a type of support service, and a type of hardware resource for the remediated customer-encountered AI model issue, (ii) identifiers for any of the service agents that participated in remediating the remediated customer-encountered AI model issue (e.g., service agent names, identification numbers, and/or other identifiers), (iii) a time to resolution of the service request, and/or (iv) other information. Resolved service request 242 may then be used to update remediated AI model issue repository 222 and/or service agent data repository 230.

Thus, by implementing the data flow shown in FIG. 2C, a system in accordance with embodiments disclosed herein may be used to assign service requests to service agents based on a qualification ranking of the service agents. By obtaining a qualification ranking of the service agents, there may be an increased likelihood of resolving service requests within prescribed time, cost, and other goals. Consequently, resources may be allocated to providing computer-implemented services and a likelihood that the computer-implemented services may be provided as desired to downstream consumers may be increased.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2C may perform various methods to manage customer-encountered AI model issues. FIG. 3 illustrates methods that may be performed by the components of the system of FIGS. 1-2C. In the diagrams discussed below and shown in FIG. 3, any of the operations may be repeated, performed in different orders, and/or performed in parallel with or in a partially overlapping in time manner with other operations.

Turning to FIG. 3, a flow diagram illustrating a method for managing customer-encountered AI model issues using service agents in accordance with an embodiment is shown. The method may be performed, for example, by any of the components of the system of FIG. 1, and/or any other entity without departing from embodiments disclosed herein.

At operation 300, a service request may be obtained for a customer-encountered AI model issue of the customer-encountered AI model issues. Obtaining the service request may include: (i) reading the service request from storage, (ii) receiving the service request from another entity, (iii) generating the service request, and/or (iv) other methods.

Generating the service request may include: (i) collecting information regarding the customer-encountered AI model issue (e.g., via a portal and/or other communication medium), (ii) populating a data structure with the information to obtain the service request, and/or (iii) other methods. The information may include any type and quantity of information regarding the customer-encountered AI model issue. The customer-encountered AI model issue may relate, for example, to a computing device (e.g., a client device) for which a management system provides management services that may facilitate remediation of the customer-encountered AI model issue.

At operation 302, a first categorization process may be performed for the service request to obtain a type of AI workload that gave rise to the customer-encountered AI model issue indicated by the service request. Performing the first categorization process may include: (i) prompting a user that provided the service request for the client device to answer a list of questions, the list of questions being based on information obtained as part of the service request and the answers being usable to determine the type of AI workload, (ii) obtaining additional information (e.g., from the user, via a backend connection to the client device) usable to determine the type of AI workload (e.g., a version of the AI model, resource consumption of the AI model, telemetry data for the client device), (iii) automatically assigning a type of AI workload to the service request based on the user answers and/or the other information (e.g., using a rule set for assigning types of AI workloads to service requests based on user answers to the list of questions, using an LLM to process text from the service request and/or other text obtained from the user and/or client device to identify a type of AI workload for the service request), (iv) manually assigning a type of AI workload to the service request based on the service request, user answers, and/or the other information (e.g., by a subject matter expert (SME) and/or service agent), (v) providing the service request and/or other information to another entity and receiving the type of AI workload in response, and/or (vi) other methods.

At operation 304, a second categorization process may be performed, based on at least the type of AI workload, to obtain a type of support service used to provide the type of AI workload. Performing the second categorization process may include: (i) obtaining the type of support service based on the information provided by the user (e.g., answers to the list of questions provided by the user indicating a type of support service, other information regarding the customer-encountered AI model issue indicating the type of support service), (ii) generating the type of support service based on the type of AI workload (e.g., based on a rule set and/or schema), (iii) prompting the user, based on the type of AI workload, to answer additional questions regarding the customer-encountered AI model issue usable to determine the type of support service, (iv) providing the type of AI workload and/or other information to another entity and receiving the type of support service in response, and/or (v) other methods.

Obtaining the type of support service based on the information provided by the user may include identifying the type of support service automatically and/or manually based on information provided by the user and/or obtained from the client device regarding the customer-encountered AI model issue. For example, an LLM may be used to automatically assign the type of support service based by analyzing text provided by the user and/or obtained from the client device. In another example, a SME and/or service agent may manually assign the type of support service by parsing the text provided by the user and/or obtained from the client device.

Generating the type of support service based on the type of AI workload may include automatically and/or manually assigning the type of support service using a rule set, schema, and/or table which maps types of AI workloads to types of support services used to provide the types of AI workloads. For example, a lookup process may be performed using the type of AI workload as a key for a lookup table to determine the type of support service.

Prompting the user to answer additional questions regarding the customer-encountered AI model issue to obtain the type of support service may include automatically providing a list of questions usable to determine the type of support service to the user based on the type of AI workload. For example, the user may be prompted to answer questions specific to the type of AI workload regarding any error messages the user may have received, at what point in the performance of the AI model workload the user encountered an issue, etc. The type of support service may then be obtained based on the answers provided by the user.

At operation 306, a third categorization process may be performed, based on at least the type of support service, to obtain a type of hardware resource used to provide the support service. Performing the third categorization process may include: (i) obtaining the type of hardware resource based on the information provided by the user (e.g., answers to the list of questions indicating a type of hardware resource, other information regarding the customer-encountered AI model issue indicating the type of hardware resource), (ii) generating type of hardware resource based on the type of support service (e.g., based on a rule set and/or schema), (iii) prompting the user, based on the type of support service, to answer additional questions regarding the customer-encountered AI model issue usable to determine the type of hardware resource, (iv) providing the type of support service and/or other information to another entity and receiving the type of hardware resource in response, and/or (v) other methods. Obtaining the type of hardware resource may include similar methods to obtaining the type of support service described in operation 304.

At operation 308, a service agent may be selected, based on at least the type of AI workload, the type of support service, the type of hardware resource, and a qualification ranking of the service agents, to remediate the customer-encountered AI model issue. The qualification ranking may be based on efficiency estimates for remediating the customer-encountered AI model issue by the service agents. Selecting the service agent may include: (i) attempting to identify a portion of the service agents that previously remediated customer-encountered AI model issues of the type of AI workload, the type of support service, and the type of hardware resource indicated by the service request, (ii) ranking the service agents of the portion of the service agents based on at least the efficiency estimates for remediating the customer-encountered AI model issue to obtain the qualification ranking, (iii) identifying, based on the qualification ranking, the service agent to remediate the customer-encountered AI model issue, and/or (iv) other methods.

Attempting to identify a portion of the service agents may include: (i) performing a lookup process in a database and/or other storage structure used to store information regarding previously remediated customer-encountered AI model issues using the type of AI workload, the type of support service, and the type of hardware resource as a key for a lookup table included in the database and/or other storage architecture, (ii) obtaining, as a result of the lookup process, the portion of service agents, (iii) providing the type of AI workload, the type of support service, and the type of hardware resource to another entity and receiving the portion of the service agents in response, and/or (iv) other methods.

Attempting to identify the portion of the service agents may also include, in an instance of the attempting where no service agent is identified that previously remediated a customer-encountered AI model issue of the type of AI workload, the type of support service, and the type of hardware resource indicated by the service request: (i) identifying a team of service agents, (ii) using the team of service agents as the service agent to remediate the customer-encountered AI model issue (e.g., resolving the service request by assigning the team of service agents to work the service request), and/or (iii) other methods. Each service agent of the team of service agents may have previously remediated a customer-encountered AI model issue of at least one selected from a list consisting of: the type of AI workload, the type of support service, and the type of hardware resource indicated by the service request. In combination, the team of service agents may have previously remediated customer-encountered AI model issues of the type of AI workload, the type of support service, and the type of hardware resource indicated by the service request.

Identifying the team of service agents may include: (i) performing a lookup process in a database and/or other storage structure used to store information regarding previously remediated customer-encountered AI model issues using the type of AI workload, the type of support service, and/or the type of hardware resource as a key for a lookup table included in the database and/or other storage architecture to identify entries including service agents that have each remediated a customer-encountered AI model issue of the type of AI workload, the type of support service, and/or the type of hardware resource indicated by the service request, (ii) selecting, from the identified entries, the team of service agents so that in combination the team of service agents includes at least one service agent that has remediated a customer-encountered AI model issue of the type of AI workload, the type of support service, and the type of hardware resource indicated by the service request, and/or (iii) other methods.

Ranking the service agents of the portion of the service agents may include: (i) obtaining an efficiency estimate for each service agent of the portion of the service agents, (ii) ordering the service agents of the portion of the service agents based on the efficiency estimates to obtain the qualification ranking, where a higher qualification ranking for a service agent indicates an increased likelihood that the service agent is able to remediate the customer-encountered AI model issue within the time to resolution goal (e.g., ranking the service agents of the portion of the service agents from lowest efficiency estimate to highest efficiency estimate), (iii) providing the portion of the service agents and/or efficiency estimates for the portion of the service agents to another entity and receiving the qualification ranking in response, and/or (iv) other methods.

Obtaining an efficiency estimate for each service agent of the portion of the service agents may include: (i) identifying an average time to remediation of previously remediated customer-encountered AI model issues of the type of AI workload, the type of support service, and the type of hardware resource that were remediated by each service agent of the portion of the service agents, (ii) identifying a level of available cognitive bandwidth for each service agent of the portion of the service agents to remediate the customer-encountered AI model issue within a time to resolution goal for the service request, (iii) calculating the efficiency estimate based on at least the average time to remediation and the level of available cognitive bandwidth for each service agent (e.g., using any algorithm and/or method for calculating efficiency estimates), (iv) reading the efficiency estimates for each service agent of the portion of the service agents from storage, (v) receiving the efficiency estimates for each service agent of the portion of the service agents from another entity, and/or (vi) other methods.

Identifying the average time to remediation may include: (i) performing a lookup process in a database and/or other storage structure used to store performance data and/or other information regarding the service agents using the type of AI workload, the type of support service, and the type of hardware resource as a key for a lookup table included in the database and/or other storage architecture, (ii) obtaining, as a result of the lookup process, the average time to remediation, and/or (iii) other methods.

Identifying the level of available cognitive bandwidth for each service agent may include: (i) obtaining an existing cognitive load estimate for each service agent (e.g., based on current service request assignments and/or other duties of the service agent), (ii) obtaining a total possible cognitive load estimate for each service agent (e.g., based on a level of skill assignment for each service agent, based on other performance data for each service agent), (iii) comparing the existing cognitive load estimate for each service agent to a corresponding total possible cognitive load estimate for the service agent to obtain a level of available cognitive bandwidth for each service agent, and/or (iv) other methods.

Identifying the service agent based on the qualification ranking may include: (i) performing a scheduling analysis to further rank the service agents based on their availability to work the service request and/or other factors that may impact an ability of the service agents to remediate the customer-encountered AI model issue within the time to resolution goal. Additionally, other factors such as a financial cost per unit time ascribed to each service agent may be taken into account. These factors and rankings may be used to identify the service agent to select through, for example, evaluation of an objective function or other tool for multivariate analysis and optimization. The objective function may take the rankings and the factors as input, ascribe numerical values usable to relatively rank the service agents, and the best ranked service agent may be selected.

At operation 310, the service request may be resolved by assigning the service agent to work the service request. Assigning the service agent to work the service request may include: (i) populating a workflow management system or other system with information indicating that the selected service agent is responsible for remediating the customer-encountered AI model issue, (ii) notifying (e.g., via a message over a communication system, via a graphical user interface (GUI) on a device) the selected service agent that they are to work the service request, and/or (iii) other methods.

The method may end following operation 310.

Once the service request is resolved, information regarding the customer-encountered AI model issue and the service agent's performance during the resolution may be used to update information upon which future service agent selections are made.

Thus, as illustrated above, embodiments disclosed herein may provide systems and methods usable to resolve service requests for customer-encountered AI model issues using service agents. By performing categorization processes for a customer-encountered AI model issue indicated by a service request, a service agent may be assigned to work the service request with an increased likelihood of remediating the customer-encountered AI model issue within prescribed goals.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing customer-encountered artificial intelligence (AI) model issues using service agents, the method comprising:
obtaining a service request for a customer-encountered AI model issue of the customer-encountered AI model issues;
performing a first categorization process for the service request to obtain a type of AI workload that gave rise to the customer-encountered AI model issue indicated by the service request;
performing a second categorization process, based on at least the type of AI workload, to obtain a type of support service used to provide the type of AI workload;
performing a third categorization process, based on at least the type of support service, to obtain a type of hardware resource used to provide the type of support service;
selecting, based on at least the type of AI workload, the type of support service, the type of hardware resource, and a qualification ranking of the service agents, a service agent to remediate the customer-encountered AI model issue, the qualification ranking being based on efficiency estimates for remediating the customer-encountered AI model issue by the service agents; and
resolving the service request by assigning the service agent to work the service request.

2. The method of claim 1, wherein the type of AI workload comprises at least one type of AI workload selected from a list of types of AI workloads consisting of:
inference generation by an AI model;
AI model deployment;
AI model distillation;
AI model training; and
AI model updating.

3. The method of claim 1, wherein the type of support service comprises at least one type of support service selected from a list of types of support services consisting of:
file systems management;
workload scheduling;
database services; and
hardware resources management.

4. The method of claim 1, wherein selecting the service agent to remediate the customer-encountered AI model issue comprises:
attempting to identify a portion of the services agents that previously remediated customer-encountered AI model issues of the type of AI workload, the type of support service, and the type of hardware resource indicated by the service request;
ranking the service agents of the portion of the service agents based on at least the efficiency estimates for remediating the customer-encountered AI model issue to obtain the qualification ranking; and
identifying, based on the qualification ranking, the service agent to remediate the customer-encountered AI model issue.

5. The method of claim 4, wherein the efficiency estimates for remediating the customer-encountered AI model issue are based on:
an average time to remediation of previously remediated customer-encountered AI model issues of the type of AI workload, the type of support service, and the type of hardware resource that were remediated by each service agent of the portion of the service agents; and
a level of available cognitive bandwidth for each service agent of the portion of the service agents to remediate the customer-encountered AI model issue within a time to resolution goal for the service request.

6. The method of claim 5, wherein the qualification ranking comprises an ordering of the service agents of the portion of the service agents based on the efficiency estimates, and a higher qualification ranking for a service agent indicates an increased likelihood that the service agent is able to remediate the customer-encountered AI model issue within the time to resolution goal.

7. The method of claim 4, wherein attempting to identify the portion of the services agents comprises:
in an instance of the attempting where no service agent is identified that previously remediated a customer-encountered AI model issue of the type of AI workload, the type of support service, and the type of hardware resource indicated by the service request:
identifying a team of service agents, wherein:
each service agent of the team of service agents has previously remediated a customer-encountered AI model issue of at least one selected from a list consisting of the type of AI workload, the type of support service, or the type of hardware resource indicated by the service request; and
in combination the team of service agents has previously remediated customer-encountered AI model issues of the type of AI workload, the type of support service, and the type of hardware resource indicated by the service request; and
using the team of service agents as the service agent to remediate the customer-encountered AI model issue.

8. A non-transitory machine-readable medium having instructions stored therein, which when executed by a processor, cause the processor to perform operations for managing customer-encountered artificial intelligence (AI) model issues using service agents, the operations comprising:
obtaining a service request for a customer-encountered AI model issue of the customer-encountered AI model issues;
performing a first categorization process for the service request to obtain a type of AI workload that gave rise to the customer-encountered AI model issue indicated by the service request;
performing a second categorization process, based on at least the type of AI workload, to obtain a type of support service used to provide the type of AI workload;
performing a third categorization process, based on at least the type of support service, to obtain a type of hardware resource used to provide the type of support service;
selecting, based on at least the type of AI workload, the type of support service, the type of hardware resource, and a qualification ranking of the service agents, a service agent to remediate the customer-encountered AI model issue, the qualification ranking being based on efficiency estimates for remediating the customer-encountered AI model issue by the service agents; and
resolving the service request by assigning the service agent to work the service request.

9. The non-transitory machine-readable medium of claim 8, wherein the type of AI workload comprises at least one type of AI workload selected from a list of types of AI workloads consisting of:
inference generation by an AI model;
AI model deployment;
AI model distillation;
AI model training; and
AI model updating.

10. The non-transitory machine-readable medium of claim 8, wherein the type of support service comprises at least one type of support service selected from a list of types of support services consisting of:
file systems management;
workload scheduling;
database services; and
hardware resources management.

11. The non-transitory machine-readable medium of claim 8, wherein selecting the service agent to remediate the customer-encountered AI model issue comprises:
attempting to identify a portion of the services agents that previously remediated customer-encountered AI model issues of the type of AI workload, the type of support service, and the type of hardware resource indicated by the service request;
ranking the service agents of the portion of the service agents based on at least the efficiency estimates for remediating the customer-encountered AI model issue to obtain the qualification ranking; and
identifying, based on the qualification ranking, the service agent to remediate the customer-encountered AI model issue.

12. The non-transitory machine-readable medium of claim 11, wherein the efficiency estimates for remediating the customer-encountered AI model issue are based on:
an average time to remediation of previously remediated customer-encountered AI model issues of the type of AI workload, the type of support service, and the type of hardware resource that were remediated by each service agent of the portion of the service agents; and
a level of available cognitive bandwidth for each service agent of the portion of the service agents to remediate the customer-encountered AI model issue within a time to resolution goal for the service request.

13. The non-transitory machine-readable medium of claim 12, wherein the qualification ranking comprises an ordering of the service agents of the portion of the service agents based on the efficiency estimates, and a higher qualification ranking for a service agent indicates an increased likelihood that the service agent is able to remediate the customer-encountered AI model issue within the time to resolution goal.

14. The non-transitory machine-readable medium of claim 11, wherein attempting to identify the portion of the services agents comprises:
in an instance of the attempting where no service agent is identified that previously remediated a customer-encountered AI model issue of the type of AI workload, the type of support service, and the type of hardware resource indicated by the service request:
identifying a team of service agents, wherein:
each service agent of the team of service agents has previously remediated a customer-encountered AI model issue of at least one selected from a list consisting of the type of AI workload, the type of support service, and the type of hardware resource indicated by the service request; and
in combination the team of service agents has previously remediated customer-encountered AI model issues of the type of AI workload, the type of support service, and the type of hardware resource indicated by the service request; and
using the team of service agents as the service agent to remediate the customer-encountered AI model issue.

15. A data processing system, comprising:
a processor; and
a memory coupled to the processor to store instructions, which when executed by the processor, cause the processor to perform operations for managing customer-encountered artificial intelligence (AI) model issues using service agents, the operations comprising:
obtaining a service request for a customer-encountered AI model issue of the customer-encountered AI model issues;
performing a first categorization process for the service request to obtain a type of AI workload that gave rise to the customer-encountered AI model issue indicated by the service request;
performing a second categorization process, based on at least the type of AI workload, to obtain a type of support service used to provide the type of AI workload;
performing a third categorization process, based on at least the type of support service, to obtain a type of hardware resource used to provide the type of support service;
selecting, based on at least the type of AI workload, the type of support service, the type of hardware resource, and a qualification ranking of the service agents, a service agent to remediate the customer-encountered AI model issue, the qualification ranking being based on efficiency estimates for remediating the customer-encountered AI model issue by the service agents; and
resolving the service request by assigning the service agent to work the service request.

16. The data processing system of claim 15, wherein the type of AI workload comprises at least one type of AI workload selected from a list of types of AI workloads consisting of:
inference generation by an AI model;
AI model deployment;
AI model distillation;
AI model training; and
AI model updating.

17. The data processing system of claim 15, wherein the type of support service comprises at least one type of support service selected from a list of types of support services consisting of:
file systems management;
workload scheduling;
database services; and
hardware resources management.

18. The data processing system of claim 15, wherein selecting the service agent to remediate the customer-encountered AI model issue comprises:
attempting to identify a portion of the services agents that previously remediated customer-encountered AI model issues of the type of AI workload, the type of support service, and the type of hardware resource indicated by the service request;
ranking the service agents of the portion of the service agents based on at least the efficiency estimates for remediating the customer-encountered AI model issue to obtain the qualification ranking; and
identifying, based on the qualification ranking, the service agent to remediate the customer-encountered AI model issue.

19. The data processing system of claim 18, wherein the efficiency estimates for remediating the customer-encountered AI model issue are based on:
an average time to remediation of previously remediated customer-encountered AI model issues of the type of AI workload, the type of support service, and the type of hardware resource that were remediated by each service agent of the portion of the service agents; and
a level of available cognitive bandwidth for each service agent of the portion of the service agents to remediate the customer-encountered AI model issue within a time to resolution goal for the service request.

20. The data processing system of claim 19, wherein the qualification ranking comprises an ordering of the service agents of the portion of the service agents based on the efficiency estimates, and a higher qualification ranking for a service agent indicates an increased likelihood that the service agent is able to remediate the customer-encountered AI model issue within the time to resolution goal.
